(19) United States
(12) Patent Application Publication
(10) Pub. No.: US 2008/0238072 A1
(43) Pub. Date: Oct. 2, 2008

(54) Manually Actuable Steering Device

(75) Inventors: Henrik Nohr Kofoed, Espergaerde (DK); Mogens Usted Bech, Birkerod (DK)

Correspondence Address: KNOBBE MARTENS OLSON & BEAR LLP, 2040 MAIN STREET, FOURTEENTH FLOOR, IRVINE, CA, 92614, US

(73) Assignee: BORRINGIA INDUSTRIE AG, Ettingen (CH)

(21) Appl. No.: 10/585,501

(22) PCT Filed: Jan. 11, 2005
(86) PCT No.: PCT/DK2005/000010

§ 371 Date: Apr. 17, 2008

(30) Foreign Application Priority Data
Jan. 13, 2004 (DK) PA 2004 00032

(51) Int. Cl. B62D 1/12; B62D 6/00

(52) U.S. Cl. 280/778; 701/42

(57) ABSTRACT

Driving and steering means of a wheeled, power driven vehicle, such as a power driven hospital bed, is actuated by an actuating device (30). This actuating device comprises a base member (31) and an actuating member (32) having gripping means, such as a pair of spaced handles (33), and being supported by the base member so as to be displaceable thereon along a plane. A first force transducer (34) is arranged to receive a force component manually applied to the actuating member in a predetermined first direction only, along said plane, and a second force transducer (38) is arranged to receive a force component manually applied to the actuating member in a predetermined second direction only, transversely to the first direction along said plane. Each of these force transducers is adapted to generate an output signal to the driving and steering means responsive to the strength of the force component received. Preferably, the first and second directions extend at mutual right angles, and one of the directions extends in the normal direction of travel of the vehicle.

### FIELD OF THE INVENTION

The present invention relates to an actuating device for manually actuating driving and steering means for a wheeled, power driven object or vehicle, especially an object or a vehicle provided with wheels of the omni-directional type, such as described in U.S. Pat. No. 6,474,434 and international patent application PCT/DK03/00623.

### DESCRIPTION OF PRIOR ART

Known actuating devices of this kind are usually in the form of a joy stick. The proper use of such joy stick requires certain training, and is quite inadequate if the operator is not actually situated on the driven vehicle.

U.S. Pat. No. 6,276,471 discloses a vehicle comprising a pair of motor driven wheels and at least one caster wheel. The power supply to the electric motors is controlled by a programmable control unit. This control unit includes a plurality of sensors arranged in each of a pair of handles or in a U-shaped stirrup for sensing a manual displacement force or a steering force applied thereto. Because it is more or less incidental which fraction of a manual driving force applied to the handles or stirrup is transferred to the respective sensors, this structure does not allow a sensitive control of the driving motors.

The problem to be solved is to provide a sensitive manual actuating device, which without preceding training may be operated by persons, who are used to push or drag a wheeled vehicle by manual forces.

### SUMMARY OF THE INVENTION

This problem is solved by the actuating device according to the invention, said actuating device comprising a base member, an actuating member having gripping means and being supported by the base member so as to be displaceable thereon (freely within certain limits along at least one plane, at least first and second force transducers, the first transducer being arranged to receive a force component manually applied to the actuating member in a predetermined first direction only, along said plane, and the second force transducer being arranged to receive a force component manually applied to the actuating member in a predetermined second direction only, transversely to the first direction along said plane, each of said first and second force transducers being adapted to generate an output signal to the steering system responsive to the strength of the force component received.

This means that the arrangement may be such that when the gripping means, such as handles or the like, are gripped by an operator and pushed or pulled in the said first direction as if the vehicle should be moved by the manual forces in that direction, the first transducer generates an output signal to the steering means causing the power drive of the vehicle to move the vehicle in said first direction with a speed being dependent on the force applied to the gripping means including a possible time dependency. Similarly, if the operator applies a manual force to the gripping means in said second direction, the vehicle is moved in said second direction with a speed dependent on the force applied to the gripping means, and if the force applied to the gripping means by the operator has components in said first and second directions, respectively, the vehicle will be driven in the general direction of the force applied. In principle, the actuating member may be displaceable along two crossing planes. In the presently preferred embodiment, however, only one displacement plane is used.

As indicated above, the gripping means preferably comprises a pair of mutually spaced gripping handles, which are fixedly mounted on the actuating member and symmetrically arranged in relation to said first predetermined direction. Furthermore, said first force transducer and a similar third force transducer, which is arranged like the first force transducer to receive a force component manually applied to the actuating member in said predetermined first direction only, are preferably arranged symmetrically in relation to the said first predetermined direction.

In case the gripping means comprise a pair of mutually spaced handles or grips, the operator may turn the vehicle by pushing one of the handles and pulling the other.

Any non-parallel set of predetermined directions may be chosen as the said first and second directions, and the manual force applied to the actuating member may then be decomposed in force components in these directions. The said first and second directions may in fact define any acute angle there between. In a preferred embodiment, however, said first and second directions extend at mutually right angles. Thus, said first predetermined direction preferably extends in the longitudinal direction or the normal direction of travel of the vehicle.

In the preferred embodiment each force transducer is fixedly mounted in relation to the base member, and each force transducer may have a force transmitting member extending into and engaging with the walls of an associated recess or track in the actuating member. Such recess or track may then be shaped such that only a force component in the said predetermined direction may be transmitted from the actuating member to the force transducer via said transmitting member.

The force transducers may be of any suitable type, which is able to perform the function described above. In the preferred embodiment, however, the force transducers comprise strain gauges, which are relatively cheap and simple to install in the actuating device. Thus, as an example, each force transducer may comprise a cantilever beam having strain gauges mounted thereon, and the force component from the actuating member may then be applied to the free end of the beam so as to generate bending stresses therein.

It is important that the frictional forces counteracting movement or displacing the actuating member in relation to the base member are kept suitably low and uniform. This may, for example, be obtained when the actuating member is freely floating on a film or layer of liquid or paste arranged between the actuating member and the base member.

It is of the utmost importance that the actuating device is stable in operation and that shocks and vibrations transferred from the vehicle to the actuating device do not adversely influence the operation of the actuating device. This may be obtained by suitable damping means for damping or prevention of vibration movements of the actuating member in relation to the base member. Such damping may be obtained in a simple manner by selecting said liquid film or layer of a liquid with a suitable viscosity, such as a layer of viscous oil or grease. Preferably, the liquid film or layer is a layer of damping grease.

The actuating device according to the invention may further comprise an electronic circuit for receiving the output signals from the force transducers and for processing these signals prior to transmitting them to the driving and steering system of the vehicle. As indicated above, this may be done so as to obtain substantially the same movement of the vehicle as if it had been manually driven by the forces applied to the gripping means, but at an intensified scale.

Another aspect the present invention relates to a method for manually actuating driving and steering means for a wheeled, power driven object or vehicle, said method comprising applying a manual force to an actuating member, decomposing the manual force into at least two components extending in mutually intersecting, predetermined directions, applying each of said force components to a respective transducer, and transmitting from each of said transducers to the steering system an output signal, which is responsive to the strength of the force component received by the transducer relating to the respective direction.

A further aspect of the present invention provides a drive wheel system or a drive wheel set for supporting and driving an object, said wheel system comprising: at least two separate wheeled units or bogies to be mounted at selected locations on the object to support the same, each unit including a frame, at least one wheel member rotatably mounted in relation to the frame, driving means for rotating the wheel member(s) in relation to the frame and steering means for moving the wheel member(s) in desired directions in relation to the frame, electronic control means for controlling the function of the driving and steering means of said wheeled units or bogies and including a pre-programmed bogie control device at each said wheeled units or bogies, signal transmitting means, and a pre-programmed central control unit for outputting command signals to each of the pre-programmed bogie control devices via the signal transmitting means in response to input command signals received, and an actuating device as described above, the output signals generated by the transducers thereof being transmitted to the electronic control means.

Thus, the present invention provides a modular kit, which may comprise driving wheeled units or bogies, power supply means, such as a power pack, and electronic control means, and which is adapted to be mounted on a broad variety of wheeled vehicles, such as wheelchairs, pallet movers, hospital beds or even industrial robots.

The division of the electronic control means into a pre-programmed central or common control unit or microcomputer, which is common to all of the wheeled units or bogies, and pre-programmed bogie control devices or micro-computers arranged at a wheeled unit each involves important advantages. Thus, data processing requiring high data transmission rates may take place inside the central control unit and the bogie control devices, respectively, while the data transmission rate between the central unit and the various bogle control devices via the data transmission means may be kept acceptably low.

By arranging the drive wheel system such that only raw power and high level, low rate data transmission to each single wheeled unit from a power source and from the central control unit, respectively, are required, true modularity and operational safety may be obtained. Furthermore, the central control unit may comprise first programming means for inputting information about the mutual positions of the wheeled units or bogies on said object and/or each bogle control device may comprise second programming means for inputting information about the orientation of the associated wheeled unit in relation to a selected common axis when mounted on said object. The first and second programming means may, for example, comprise simple digital switches, so that persons without expert knowledge may install and program the drive wheel system according to the invention on a selected object based on simple written or oral instructions.

The invention renders it possible to use a standard drive wheel system for rendering any object, such as a load carrying platform or a vehicle, including wheeled hospital beds, self-propelling and extremely maneuverable. Thus, the object may be provided with two or more wheeled units or bogies, and the operation of these units are co-ordinated by the central control unit, regard being paid to the individual and relative positions of the wheeled units or bogies on the object.

As indicated above, the system according to the invention allows vehicle manufacturers with no or little understanding of power driven omni directional wheels, engines, electronics, software and drive geometry to render their vehicles omni directional, simply by mounting the modular system onto the vehicle. Furthermore, such a system also allows owners of existing manually driven vehicles to render their vehicles power driven and omni directional in a very simple manner.

The drive wheel system according to the invention comprises a command or actuating device for inputting command signals to the central control unit, whereby an operator can control the movement of the wheeled object or vehicle. The command device may comprise a further manually operable steering device, such as a joystick, a steering wheel and/or one or more steering levers, and switching means may allow optional switching between the actuating device and any other type of steering device.

The central electronic control unit may be handheld, for example together with the actuating device or steering device. Preferably, however, the control unit and the actuating device are mounted on the object or vehicle. Alternatively or additionally, the command or actuating device may comprise a wireless remote control, such as e-mail or mobile phone. Such remote control may also be used to monitor, diagnose, or re-program individual modules or the total drive wheel system.

Alternatively or additionally, the electronic control unit may be pre-programmed so that the wheeled object may be driven along a selected path in accordance with such pre-selected program so that no manual steering is necessary.

In order to obtain correct steering movements of the wheel members the central electronic control unit is preferably programmed to ensure that the steering means are moving all wheel members of the wheeled units or bogies mounted on the said object in such a manner that at any time during driving, all wheel members are either moving along substantially parallel paths or along concentric arcs of circles and with speeds matching the Individual paths.

In principle, the signal transmitting means could merely be in the form of wires or electrical conductors. However, in order to prevent possible ground loops passing unintended loop currents, which might corrupt the proper functioning of the total system, the signal transmitting means preferably comprise a galvanic isolating device. Such device may, for example comprise an optocoupler. An optocoupler is a device or chip comprising a light source (typically an LED) emitting light to a photo sensor when activated. The photo sensor may be a photo diode or a transistor, which is activated when hit by light from the light source. Because the electrical connections of the light source and the photo sensor may be widely separated on the chip, galvanic separation between these two components to a high voltage level may be obtained.

Preferably, the central control unit comprises means for transforming output command signals to be transmitted to the bogie control devices at the wheeled units or bogies into serial digital strings, whereby information may be transferred to the bogie control devices, for example via optocouplers, with high efficiency.

From the above it is clear, that an optocoupler can transfer information encoded as a digital serial string with high efficiency. At the same time, the device ensures complete galvanic separation of the communicating circuits on either side of the optocoupler, thereby preventing possible ground loops passing unintended loop currents, which might otherwise corrupt the proper functioning of the total system. This is an important aspect in a system intended for high reliability while maintaining freedom of location of the bogie modules in an overall assembly design, particularly in the case of a user without specialized electronic knowledge.

It should be understood that according to the present invention the electronics of the electronic control means could advantageously be divided into the central control unit on one hand and each of the bogle control devices on the other hand so as to minimize data transmission via the signal transmitting means.

In order to make use of an isolating device that is specifically capable of mono-directional or bi-directional transfer of digital data on serial format, it is fundamentally necessary, that data handling capability is to be present on either side of such isolating device, with suitable programs encoded to transform commands of whatever form into serial digital strings and visa versa.

The microcomputer(s) in the central control unit is/are arranged to transform joystick or similar manual inputs into data strings prescribing bogie movements in terms of wheel speed and wheel direction as requested to achieve the overall response of the total mobile unit. The command bandwidth for communication at this level is not very demanding and consequently the required data rate is not very high.

The microcomputer(s) in each wheeled bogie is/are arranged to transform the received data strings, prescribing overall bogie movement, into the closed loop control commands handling very precisely wheel direction and wheel rotation movements and the mutual relations between these, while at the same time being exposed to external disturbances in the form of sudden transient load variations etc. to accurately achieve the prescribed bogie movement. This involves rather high data rates, which can thus be kept internal, locally in each bogle control device and need not be communicated to the overall central control unit.

The driving and steering means of the wheeled units or bogies may comprise motors selected from the group consisting of electric motors, hydraulic motors, pneumatic motors, steam engines, thermodynamic engines, and internal combustion engines.

In principle, the wheeled units or bogies of the drive wheel system according to the invention may be different in various aspects. Preferably, however, the wheeled units or bogies of the system are substantially identical. Apart from the electronic bogie control device the wheeled unit may be of any omni directional type, such as those disclosed in the above patent publications. Preferably, however, each wheel member of the wheeled units or bogies is of the type comprising a support member, a wheel element and a drive shaft, the drive shaft having a drive means engaging a drive surface on the wheel element to rotatably drive the wheel element relative to the support member, the drive shaft having a longitudinal axis and the engagement of the drive means and drive surface defining in vertical cross-section a line of engagement that is at an acute angle to the longitudinal axis, the wheel element having a surface contacting portion extending about its periphery and positioned such that it is intersected by the line of engagement substantially at where it contacts a supporting surface.

When a pair of identical driving wheels is moving along parallel paths, their respective speeds may differ slightly even though they are rotated synchronously, because the effective diameters of the wheels will differ a little due to manufacturing tolerances and/or load conditions. Thus, after a short driving distance the two wheels may build up an internal stress force in their driving structures because the two motor armatures of the wheel drives will draw effectively opposing armature currents on top of the cooperating currents used for driving.

This means a futile spending of battery power, which only generates heat in the motors and degrade the overall capability of the diving system.

In order to remedy this deficiency, the two motor armature currents are preferably continuously monitored, and in case conflicting values are observed, the control software contains a routine, which will modify the commanded speed of one or both of the two wheels in a way so as to ease out the observed stress situation.

This strategy is here described in relation to the mutual operation of just two wheels, but is not limited to this. The principle applies equally to clusters of wheels, where such conflicts may arise in several combinations and can be dealt with in accordance with the same principle.

According to a still further aspect, the present invention provides a method of rendering an object self-propelling by means of a drive wheel system of the type described above, said method comprising: mounting at least two of said wheeled units or bogies on the object at selected locations thereof and with selected orientations in relation to a certain direction, programming said first programming means by inputting information about the mutual positions of the wheeled units or bogies on said object, programming said second programming means by inputting information about the orientation of the associated wheeled unit in relation to a selected direction, and inputting command signals to the central control unit by means of the command or actuating device so as to move the vehicle along a desired path.

The wheeled units or bogies may be installed at any selected suitable location, and information to be encoded into the central control unit about the mutual positions of the wheeled units or bogies may be based on the positions in relation to an actual or imaginary co-ordinate system fixed with respect to the object on which the system is to be installed. In such case the said selected direction may be one of the axes of the co-ordinate system.

The electronic control means are preferably pre-programmed to ensure that the steering means are moving all wheel members of the wheeled units or bogies mounted on the said object such that any time during driving, all wheel members are either moving along substantially parallel lines or substantially concentric arcs of circles and with mutually matching velocities.

The object to be rendered self-propelled may be a manually driven vehicle having a plurality of supporting wheels, at least some of these wheels being replaced so as to have the vehicle supported by at least two of said wheeled units or bogies and freely swivelling wheels or casters, only.

Apart from transmission of raw power, the wheel system according to the present invention only requires high level, low rate data transmission from the central control unit to the bogle control devices at the respective wheeled bogies, whereby true modularity and operational safety is obtained in a manner, which does not require specially trained persons.

### BRIEF DESCRIPTION OF THE DRAWINGS

The invention will now be further described with reference to the drawings, wherein

FIG. 1 is a perspective view of an embodiment of the actuating device according to the invention,

FIG. 2 is a side view of the actuating device shown in FIG. 1,

FIG. 3 diagrammatically illustrates an embodiment of a drive wheel system,

FIG. 4 is a sectional view of a preferred drive wheel to be used in connection with the present invention,

FIG. 5-10 diagrammatically illustrate an embodiment of the drive wheel system according to the invention and various operational steps,

FIG. 11 illustrates a pallet mover, on which the modular drive wheel system shown in FIGS. 3-10 has been mounted,

FIG. 12 illustrates a hospital bed with the drive wheel system shown in FIGS. 3-10 mounted thereon.

FIG. 13 is a simplified representation of a chassis provided with a drive wheel system according to the invention, for example a person hoist,

FIGS. 14 and 15 are a representation of the motion geometry of the wheeled chassis shown in FIG. 13,

FIG. 16 is a block diagram illustrating an embodiment of the central control unit of the wheel drive system and the actuating device for manually controlling the operation of the system, and

FIG. 17 is a block diagram showing an embodiment of an electronic bogle control device arranged at each of the bogie modules or wheeled units.

### DESCRIPTION OF PREFERRED EMBODIMENTS

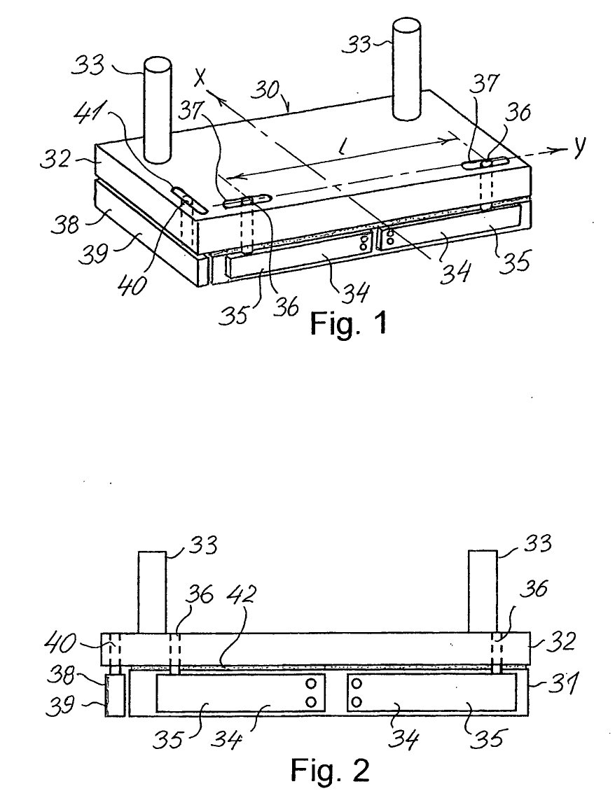

The command or actuating device 30 shown in FIGS. 1 and 2 comprises a base plate 31, which may be fixedly mounted on a wheeled vehicle, such as any of the following types: Wheelchairs, patient hoists, shower chairs, commode chairs, transport chairs, walking aids, forklifts, palette movers, work tables, robots, distribution trolleys, mobile work platforms, luggage trolleys, shopping trolleys, hospital beds, hospital cabinets, hospital waste containers, construction vehicles, earth moving vehicles, mining vehicles, and bomb disposal vehicles or any other powered vehicle. An actuating plate or a control plate 32 provided with a pair of upwardly ending, spaced handles 33 is positioned on top of the base plate 31, and the top surface of the base plate 31 and the opposite bottom surface of the actuating plate 32 are complementary shaped and preferably plane or slightly curved.

In the embodiment shown in FIGS. 1 and 2 the plates 31 and 32 define a substantially rectangular outline, and a pair of force transducers 34 are mounted on a longer edge surface of the base plate 31. Each force transducer 34 comprises a cantilever beam 35 fastened to the base plate 31 at the middle thereof, and the beams extend in opposite directions towards the opposite free ends of the base plate. A pin 36 is fastened to each cantilever beam 35 at its free end and extends upwardly into a narrow elongated recess or slot 37 formed in the control plate 32 so as to define opposite slot surfaces extending mutually parallel and substantially parallel with the corresponding cantilever beam 35 for engaging the said pin 36. Similarly, a force transducer 38 comprising a cantilever beam 39 is mounted on a shorter edge surface of the base plate extending at right angles to the longer edge surface. A pin 40 is fastened to the free end of the cantilever beam 39 and extends upwardly into a narrow elongated recess or slot 41 formed in the control plate 32 extends at right angles to the slot 37 and also defines opposite slot surfaces extending mutually parallel and substantially parallel with the corresponding cantilever beam 39 for engaging the pin 40.

Each of the force transducers 34 and 38 further comprises a strain gauge incorporated in or fastened to a surface part of the beam. Each of these strain gauges are adapted to generate an output signal in response to bending stresses caused in the corresponding cantilever beam 35, 39. The strain gauges may be electrically connected to an electronic control system as described more in detail below.

A film or layer 42 of a viscous liquid, such as damping grease, is arranged between the bottom surface of the control plate 32 and the top surface of the base plate 31. The handles 33 are preferably arranged symmetrically about a central axis X extending at right angles to the cantilever beams 35. When an operator grips the handles 33 and pushes or pulls the handles and, consequently, the control plate 32 in the direction of the axis X, the pins 36 are displaced in the direction of the axis X, whereby the two cantilever beams 35 are equally bent. This means that the corresponding strain gauge will generate identical output signal responsive to the strength of the force applied to the handles 33 by the operator.

The plates 31 and 32 and the cantilever beams 35 and 39 are preferably made from metal, such as stainless steel or aluminium, but all or some of the parts may alternatively be made from suitable plastic materials.

If the handles 33 are pushed to the right or to the left in the direction of the axis Y extending at right angles to the axis X the control plate 32 and the pin 40 are displaced in the direction of the axis Y, whereby a corresponding bending force is applied to the free end of the cantilever beam 39. Therefore, the strain gauge arranged on the beam 39 will generate an output signal responsive to the strength of the force applied to the handles 33 by the operator. If, however, the operator applies a pushing or pulling force to the handles 33 in any other direction than those of the axes X and Y, all of the transducers 34 and 38 are activated. In fact, the force applied is decomposed into components directed along the axes X and Y, respectively, and corresponding output signals are generated by the strain gauges or the force transducers 34 and 38. If an operator wants to turn a wheeled vehicle controlled by means of the actuating device 30, he or she spontaneously pulls one of the handles 33 and pushes the other, as if the operator would move the vehicle exclusively manually.

In FIG. 1 the length l is the distance between the pins 36 of the transducers 34. As explained above, forces applied to the handles 33 of the control plate 32 relative to the base plate 31 will result in electric output signals from the respective transducers 34, 38, and these signals can be amplified to useful magnitudes by normal, well known means. Amplified electric signals will be obtained from each of the transducers 34, 34 and 38 may be labelled x₁, x₂ and y, respectively. By combining these signals using normal means, command signals relevant to an omni-directional vehicle can be obtained as follows:

| | | |
|---|---|---|
| Longitudinal force command | “X” = (x₁ + x₂)/2 | V/N |
| Lateral force command | “Y” = y | V/N |
| Torque command | “ω” = (x₁ − x₂)/I | V/Nm |

These commands may then be translated into power driven movements of the omni-directional vehicle by methods described below and in international patent application PCT/DK03/00623.

Consequently, an operator grabbing the handles 33 and applying directional forces thereto, will be able to control the movements of a power driven vehicle as if he/she were moving a similar free wheeling vehicle by grabbing and pushing it directly. Any actual drive resistance due to load on the vehicle will be absorbed and overcome by the power drive of the vehicle, the operator only feeling such apparent inertia or drive resistance as has been laid down in the control program which translates forces applied by the operator into the actual drive motions of the vehicle.

As mentioned above, the control plate 32 is free to glide on top of the base plate 31 and is only restrained in this movement by the elastic reactions of the force transducers. This constitutes a mass-spring entity, which inherently supports a resonance frequency given by the mass of the control plate together with anything fixed onto it in combination with the stiffness of the force transducers, assuming that the mass of the base plate dominates the system. When the base plate 31 is mounted on some structural member of an omni-directional vehicle, there is an appreciable risk, that vibrations transmitted through this structural member may activate vibrations of the control plate 32 relative to the base plate 31 at or near this resonance frequency with the possible result, that sustained oscillations may occur, which would be detrimental to the proper control of the vehicle.

According to the present invention, this problem may be solved by any of or by a combination of the following countermeasures:
By proper choice of transducer stiffness and control plate mass the natural frequency of resonance is placed so high as to make it unlikely, that such frequencies should successfully be transmitted through the supporting structural member.
By introduction between base plate and control plate a suitable type of lubricant, giving a purely viscous drag of the right magnitude to render the mass-spring second order system just critically or possibly slightly over-critically damped, the free oscillation will be prevented and any disturbing influence from outside is closed out, still leaving the operators command actions unimpaired down to a very low signal level, permitting very accurate control of the vehicle in a confined environment.
By arranging for a suitably restricted bandwidth of the electronic amplifier system.

As mentioned above a type of liquid or lubricant, which meets the above requirements, is known as Damping Grease and is generally used in optical equipment.

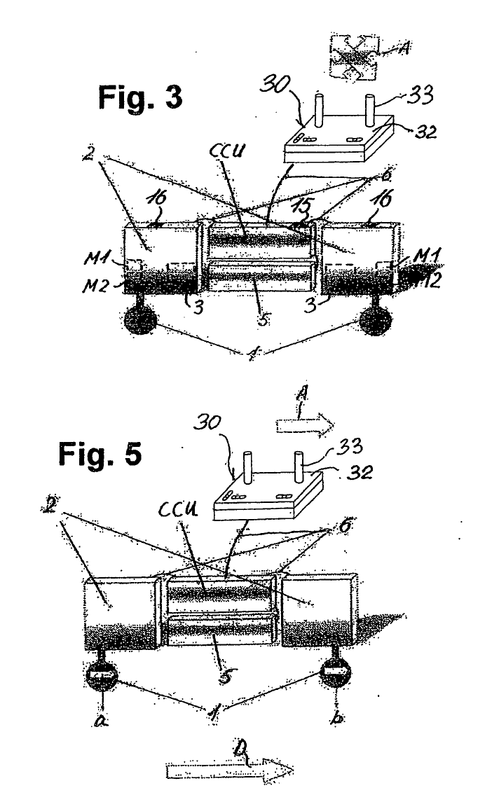

FIG. 3 diagrammatically shows an embodiment of the drive wheel system according to the invention in the form of a modular system or kit. Thus, the system comprises two or more (in FIG. 3 two are shown) wheeled units or bogle modules 2 each having at least one omni-directional drive wheel 1. Each module 2 further includes a directional motor M1 and drive motor M2 diagrammatically indicated by dotted lines, and a power pack module 5 for supplying power to the motors M1 and M2 via connecting cables 6. The operation of the wheeled bogie modules 2 is controlled by means of a central control module or unit CCU or microcomputer provided with suitable software, and by means of a man/machine interface, namely the actuating device 30 (FIGS. 1 and 2), from which control input signals may be sent to the central control unit CCU. Control output signals from the central control unit CCU are transferred to a pre-programmed electronic bogie control device 3, such as a microcomputer, at each of the bogie modules 2. The drive wheel system shown in FIG. 3 may be mounted on any given object without wheels, or on a vehicle so as to replace all wheels thereon not being freely swiveling wheels, whereby the vehicle is rendered omni directional. Non-freely swiveling wheels should be replaced either by wheeled bogle modules according to the invention or by free swiveling wheels or caster wheels. The bogie modules 2 can be mounted directly on a vehicle using traditional fastening means and methods, possibly via mounting brackets 10 (FIG. 11).

Depending on the size, nature and weight of the object or vehicle, which one wants to render power driven and omni directional according to the present invention, the size and type of the omni-directional drive wheel(s) of each bogle module may be varied. Similarly, the type and power of the motors or engines chosen for controlling direction and for driving may be varied. Thus, for small or light vehicles electrically powered motors may be ideal, while internal combustion engines, hydraulic or pneumatic engines might be preferred for heavy vehicles.

As an alternative to the power pack module 5, power may be supplied to the drive wheel system from external sources or under circumstances kept in storage in the wheeled bogie module 2 itself.

A suitable number of the said wheeled bogie modules 2 may be mounted on any given vehicle at any location best suited to the specific requirements of the vehicle in question. Subsequently, the central control unit CCU must be encoded with the position of each wheeled bogie module 2 on the vehicle. In practical applications, the central control unit CCU will have to be encoded with the co-ordinates of each bogle module 2 on the mobile chassis, and each bogie module 2 must be encoded with its orientation relative to the co-ordinate system of the mobile chassis. For this purpose, suitable programming means, such as digital switches 15 and 16 (indicated in FIG. 3), may be provided on the bogie control devices 3 and on the central control unit CCU, respectively. Once this information has been defined and stored in the central control unit CCU and the bogie control devices 3 has been provided with information about their orientation as described below, the modular omni-directional power drive system is ready for use.

Whichever way the control unit CCU would transmit individual commands from the actuating device 30 to the wheeled bogle modules 2 related to the location of each module fitted on the vehicle, a co-ordinated movement in the horizontal plane of the total vehicle is achieved. The object or vehicle could be combined of two or more mutually articulated or telescopically interconnected subunits each provided with one or more bogie control device(s) 2 and the central control unit CCU may then control the movement of each bogle so as to obtain movement of the total vehicle including mutual movement of the subunits. Communication between the control unit CCU and the bogie control devices 3 of the wheeled bogie modules 2 can take place via connecting cables 6, via radio signals or whichever form of communication is best suited to fit the vehicle in question.

As already mentioned, the power pack module 5 may be a separate unit or under circumstances be contained in one or more of the wheeled bogie modules 2. Alternatively, it may be united with the central control unit CCU, which in itself may be a self-contained unit or be part and parcel with the man/machine interface module 4. In certain cases the power required may already be part of the drive vehicle itself and thus not be required as a new item to be added to the drive vehicle.

Likewise, the control unit CCU may be a unit in its own right or—more preferred—it may be united with the man/machine interface in the form of the actuating device 30, as the function of these two units are closely related.

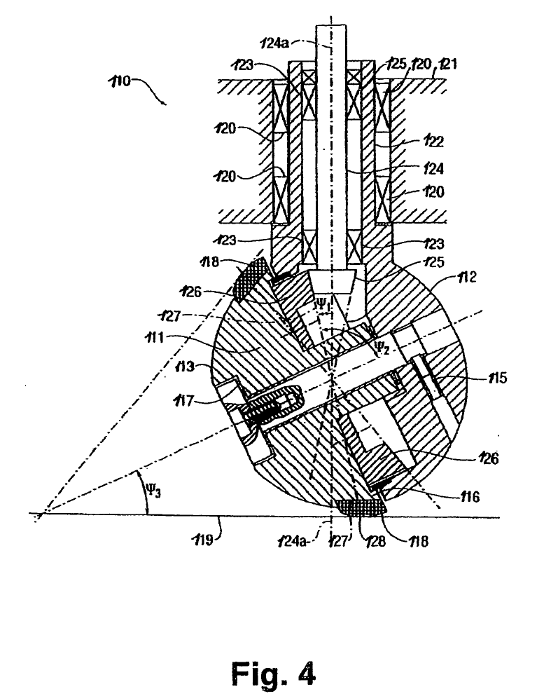

FIG. 4 illustrates a presently preferred drive wheel 110 to be used in the wheel bogies of the present invention and of the type disclosed in U.S. Pat. No. 6,474,434, which is hereby incorporated herein by reference. It should be understood, however, that any other similar omni-directional drive wheel could be used.

This drive wheel 110 includes a wheel member 111 capable of rotating relative to a support member 112 about an axle that is fixed to the support member 112 by a screw 115. The wheel member 111 has a frusto-spherical outer surface 113 and first and second end surfaces 116 and 117, respectively. An elastomeric tread 118 extends around the periphery of the wheel member 111 adjacent to the first end surface 116. A curved outer surface of the tread defines a rolling line 128 that contacts the ground surface 119 over which the wheel member 111 travels when in use.

A tubular steering or support shaft 122 extends downwardly from the bogie module 2 rotatably mounted in bearings 120, which are arranged between the bogie 2 and the support member 112. A drive shaft 124 is mounted concentrically within the tubular steering or support shaft 122 by means of bearings 123. The drive shaft 124 may be rotated by the drive motor M2 diagrammatically indicated in FIG. 1. Similarly, the steering shaft 122 may be rotated by the steering motor M1 (FIG. 3).

The free end of the drive shaft 124 adjacent to the wheel member 111 has a bevel pinion 125 engaging with a crown wheel 126 mounted on the end surface 116 of the wheel member 111. As shown in the sectional view in FIG. 4, the pinion 125 and the crown wheel 126 defines a line of engagement 127 that is at an angle to the longitudinal axis 124a of the drive shaft 124. Accordingly, when the drive shaft 124 is rotated about its longitudinal axis 124a by the drive motor M2 under the control of the central control unit CCU and the bogie control device 3 at the bogie 2, the wheel member 111 is rotated relative to the support member 112 and so that the wheel member 111 is driven over the ground or floor surface 119. The curved outer surface of the wheel tread 118 is intersected by the line of engagement 127 of the gears 125, 126 at the rolling line 128.

FIGS. 5-10 disclose only one embodiment of the modular components of the system according to the invention, which may be controlled by an operator via the actuating device 30. While the system according to the invention may be mounted on an infinite variety of different objects or wheeled vehicles, the invention is assumed to be mounted onto some kind of vehicle (not shown) having only free swiveling wheels or casters of its own.

In FIG. 5 the handles 33 and the control plate 32 connected thereto have been pushed to the right as indicated by arrow A, which causes both wheels 1 on the two wheeled bogie modules 2 to be turned towards the right a, b. Then the motors or engines M2 are activated, and the entire vehicle will move to the right as indicated by an arrow D.

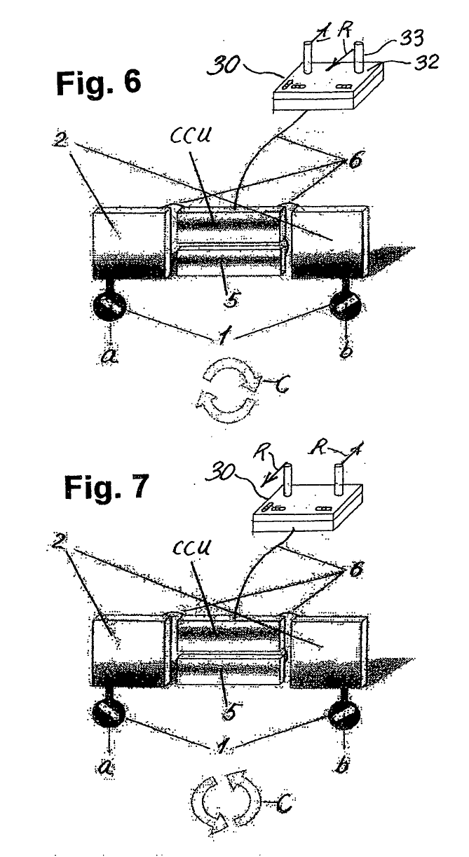

In FIG. 6 the operator pulls the right handle 33 and pushes the left handle 33 as indicated by arrows R, whereby the steering motors M1 causes the wheels 1 on the two wheeled bogie modules 2 to orientate themselves at mutually oblique angles relative to the athwart direction of the vehicle a, b. Then the drive motors M2 are activated and the entire vehicle will rotate clockwise around a centre of rotation as indicated by arrows C and identified by the angular orientation a, b of each of the two wheels 1.

In FIG. 7 operator pulls the left handle 33 and pushes the right handle 33 as indicated by arrows R, which causes the wheels 1 on the two wheeled bogie modules 2 to orientate themselves at mutually oblique angles relative to the athwart direction a, b of the vehicle. Then the drive motors M2 are activated, and the entire vehicle will rotate counter clockwise around a centre of rotation Identified by the angular orientation a, b of each of the two wheels.

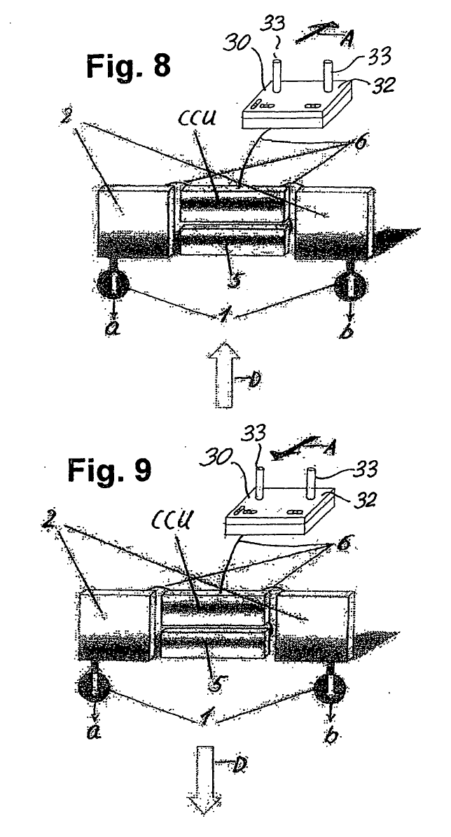

In FIG. 8 the handles 33 are pushed to forwards (arrow A) causing both wheels 1 on the two wheeled bogle modules 2 to be turned parallel to the longitudinal direction a, b of the vehicle. Then the drive motors or engines M2 (FIG. 1) are activated, and the entire vehicle will move forwards.

In FIG. 9 the handles 33 are pulled backwards as indicated by the arrow A, which causes the steering motors M1 (FIG. 1) to turn both wheels 1 on the two wheeled bogie modules 2 parallel to the longitudinal direction a, b of the vehicle. Then the drive motors or engines M2 are activated, and the entire vehicle will move backwards as indicated by the arrow D.

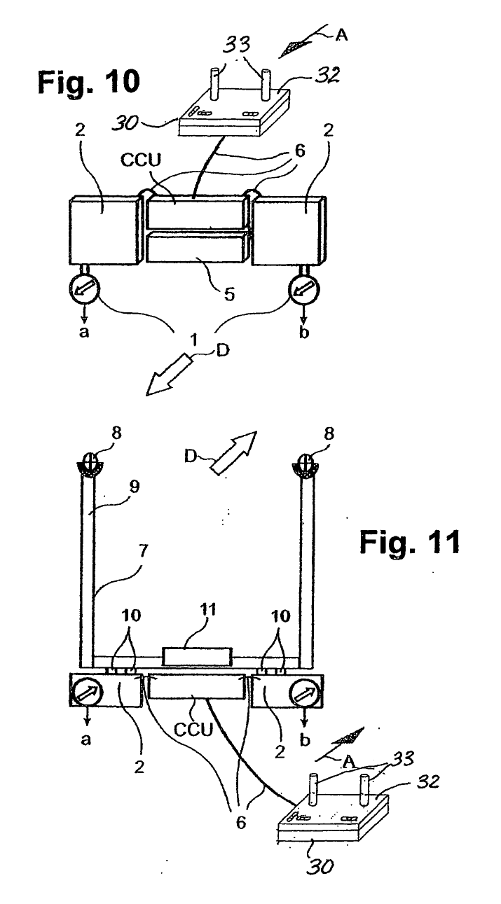

In FIG. 10 the handles 33 are pulled backwards at an oblique angle as indicated by the arrow A causing both wheels 1 on the two wheeled bogie modules 2 to be turned mutually parallel at the same oblique angle (indicated by arrow D) as the joystick relative to the longitudinal direction a, b of the vehicle. Then the drive motors M2 are activated, and the entire vehicle will move in that same oblique direction.

In FIG. 11 the modular system according to the invention is mounted on an undercarriage 9 of a stylised pallet mover 7 with freely swiveling front wheels 8, and both wheeled bogle modules 2 are mounted at the rear end of the pallet mover by means of mounting brackets 10. The lifting fork of the pallet mover 7 and the stylised hoisting mechanism 11 are shown or completeness. The driving characteristics of the vehicle illustrated in FIG. 11 are as illustrated in FIGS. 5-10 and as described in connection therewith.

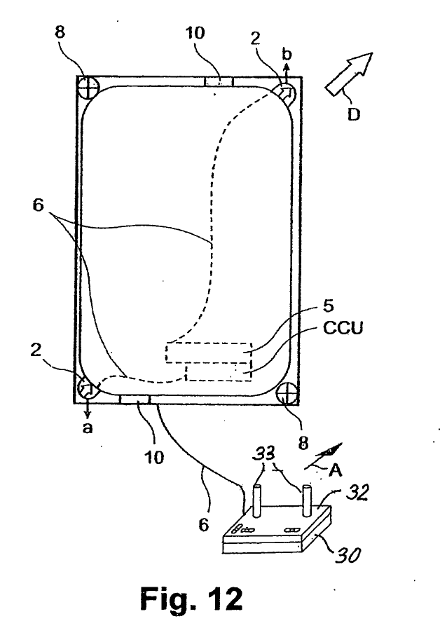

In FIG. 12 the system according to the invention is shown mounted underneath a stylised hospital bed with two freely swiveling wheels or casters 8. In this example the wheeled bogie modules 2 are fitted at diagonally opposite corners of the bed to Illustrate the freedom of mounting of the wheeled bogie modules on the vehicle in question subject to the one proviso that the actual location of each wheeled bogle module is encoded into the storage memory of the central control unit CCU as explained later more in detail. The entire driving characteristics of the vehicle illustrated in FIG. 12 will then again be explained above end as illustrated in FIGS. 5-10.

One or both of the two freely swiveling wheels 8 on the stylised hospital bed in FIG. 12 may be substituted by additional wheeled bogie modules 2 with the one proviso that the actual location of each additional wheeled bogie module is likewise encoded into the storage memory of the central control unit CCU.

In principle, any desired number of wheeled bogie modules 2 according to the invention may be mounted on an object or vehicle.

### Principles of Drive Control

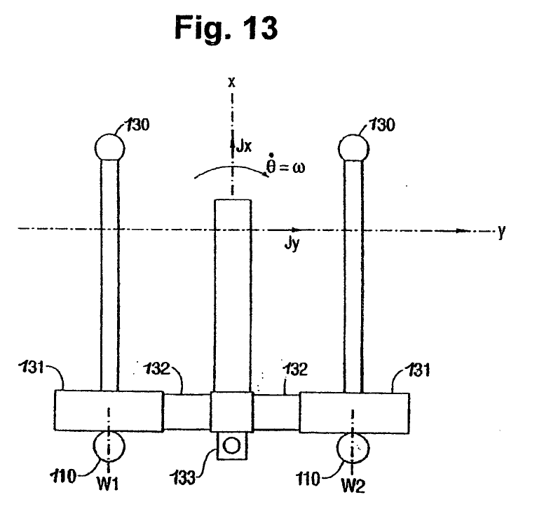

FIG. 13 is a simplified representation of an object or a chassis, which has been rendered omni-drivable by mounting a drive wheel system according to the invention thereon. Thus, the chassis shown has been provided with two bogie modules 2 each having a drive wheel 110 and two standard non-driven, freely swiveling wheels 130. The chassis shown in FIG. 13 is capable of undergoing change in lateral dimension simply by a movement of the respective drive wheels either relatively towards or away from each other. In this embodiment the chassis can be considered composed of two sub-carriages 131 having lateral members 132 that can telescopically or otherwise move with respect to each other. Mutual movement of the sub-carriages may be obtained simply by driving the two drive wheels 110 either towards or away from each other thereby allowing the lateral dimension of the chassis to be adjusted. In the arrangement depicted in FIG. 13, the lateral members 132 may move so as to ensure that the respective distances of the drive wheels 110 from a central linking housing 133 remain symmetrical relative to the housing 133. The capability of the chassis to adjust its lateral dimensions can be particularly useful when the chassis has to pass through a narrow opening, such as a door opening. FIG. 13 gives an example of a reference co-ordinate system and axis orientation for translatory motion and rotation.

When a drive wheel system according to the invention has been mounted on an object or vehicle to be rendered self-propelling, the central control unit CCU controlled by commands from the actuating device 30, as well as the bogie control devices 3 (FIG. 3) at the bogie modules 2 have to be programmed in order to obtain a correlated function of the various parts of the system. For this purpose it is useful to utilise an imaginary co-ordinate system located in a plane parallel to the ground or floor surface 119 (FIG. 4) so that the axis of abscissas or x-axis defines the forwards/backwards movement while the ordinate axis or y-axis defines the transverse or sideways movement of the chassis relative to an arbitrary reference point. In FIG. 13 forward movement from the reference point is considered movement in a positive direction along the x-axis and sideways movements to the right from the reference point is considered movement in a positive direction along the y-axis. Any rotation about the reference point is considered positive if the rotation is clockwise when viewed from above.

As indicated above, the chassis exemplified in FIG. 13 may telescopically change its width. This width variation is termed SHIFT and is obtained purely by wheel control without any internal telescope drive, merely referring to a mechanical link (or roller chain and sprockets) to ensure symmetry (or any other defined relation) of the two sub-carriages 131 relative to the central body 133. The necessary feed back information to the control unit may, for example, be derived from one of the sprockets.

For the purpose of understanding the operation of the drive motor M2 and the steering motor M1, reference will be made to the following definitions:

| SYMBOL | DESCRIPTION | DIMENSION |
|---|---|---|
| Jx | X-command, normalised. | m/s |
| Jy | Y-command, normalised. | m/s |
| ω | Turn command, normalised. | rad/s |
| U | Speed command, normalised. | m/s |
| Wx | Wheel X-co-ordinate | m |
| Wy | Wheel Y-co-ordinate | m |
| VW | Wheel speed command | m/s |
| VWx | Wheel speed X-command | m/s |
| VWy | Wheel speed Y-command | m/s |
| φ | Input command direction | Radian |
| ψi | Wheel direction command | Radian |
| S′y | K1(Wyl − Wyo). SHIFT of Wx and Wy. | m/s |
| K1 | Shift time constant | s⁻¹ |
| K2 | Rate feed forward | Nondim |
| K3 | Proportional gain | s⁻¹ |
| K4 | Wheel offset | m |

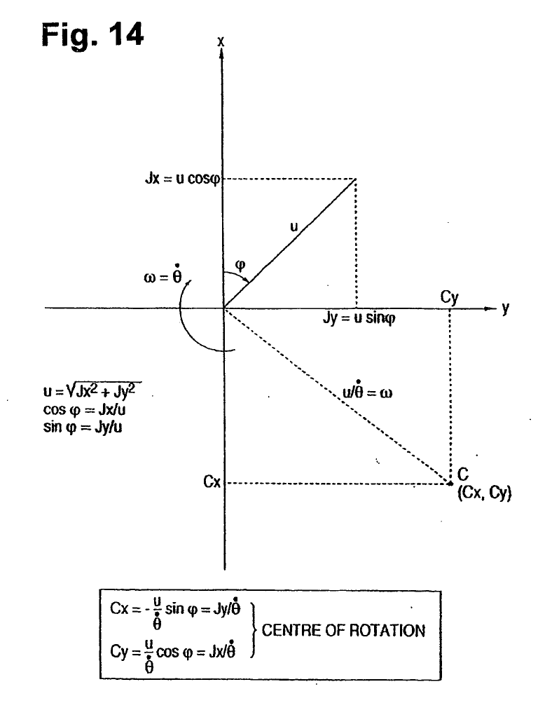

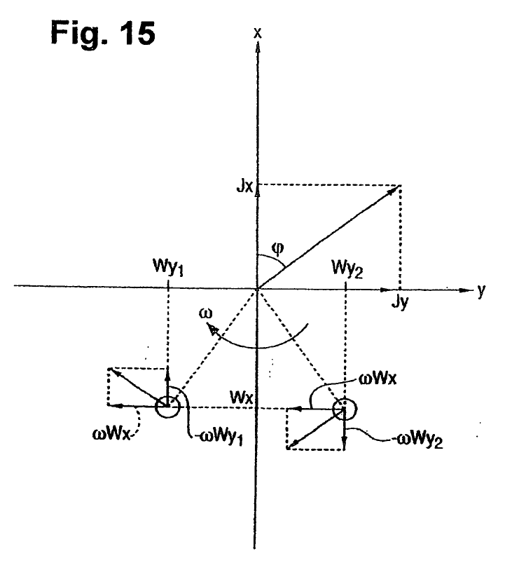

The general movement of a drive carriage can be described at any given moment as a rotation about some point in the ground surface, or as the linear superposition of a movement of pure translation and a rotation about the reference point. From this the motion geometry appears from FIGS. 14 and 15, and the following control equations follow:

VWx=Jx−ωWy

VWy=Jy+ωWx+s′y

$$\begin{matrix}{V}_{W} = \sqrt{{( U cos ϕ - ω {W}_{y} )}^{2} + {( U sin ϕ + ω {W}_{x} + {s}_{y}^{′} )}^{2}} \\ = \sqrt{{( {J}_{x} - ω {W}_{y} )}^{2} + {( {J}_{y} + ω {W}_{x} + {s}_{y}^{′} )}^{2}}\end{matrix}$$

$$cos {ψ}_{i} = \frac{U cos ϕ - ω {W}_{y}}{{V}_{w}} = \frac{{J}_{x} - ω {W}_{y}}{{V}_{w}}$$

$$sin {ψ}_{i} = \frac{U sin ϕ + ω {W}_{x} + {s}_{y}^{′}}{{V}_{w}} = \frac{{J}_{y} + ω {W}_{x} + {s}_{y}^{′}}{{V}_{w}}$$

### Central Control Unit

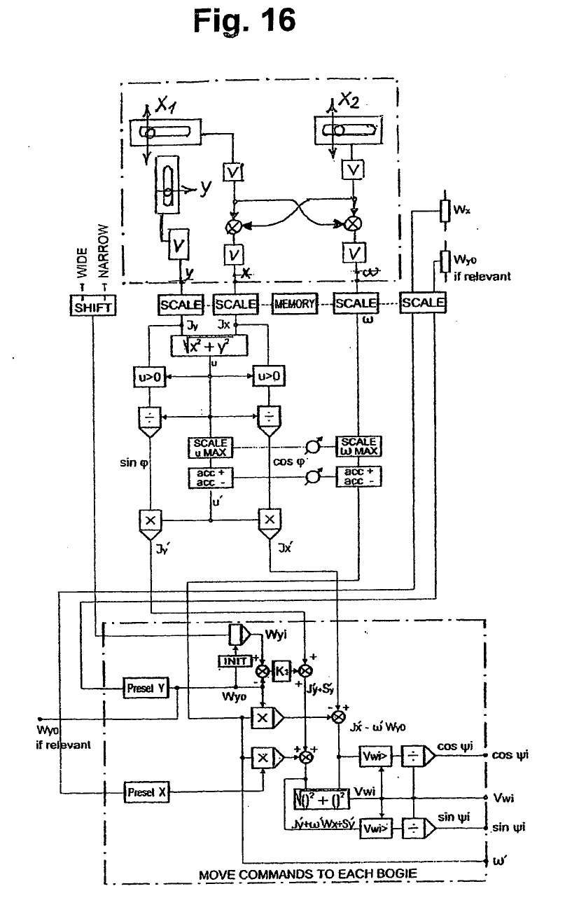

FIG. 16 is a schematic block-diagram of an embodiment of the central control unit CCU. The control unit illustrated in FIG. 16 comprises three signal transmitters indicated by 20 associated with the actuating device 30, namely an X₁-gauge and an X₂-gauge for the longitudinal commands, a Y-gauge for the athwart command, the rotation command ω being derived from the two longitudinal commands as previously described.

The central control unit further comprises a Wx-potentiometer for manual setting of the Wx-co-ordinate and a Wyo-potentiometer for the feedback of the actual Wyo-co-ordinate as measured by the telescopic movements between the two drive bogies if required. All the values are subject to ADC-conversion and subsequent scaling to obtain identifiable dimensional values. The scale factors are saved in a memory when the circuit is off power. After the digital scalers, the corresponding values Jx, Jy and ω appear on normalised form independent of individual device tolerances. The command speed components Jx and Jy are now combined to the normalised speed command U. From these values sin φ=Jy/U and cos φ=Jx/U are obtained subject to U>0.

The two values U and ω are now modified through scale factors to obtain suitable full scale deflection speeds in accordance with the operator's requirement. Similarly the command values are subject to maximum acceleration and deceleration restrictions through selectable filters.

These modified values are U′ and ω′. Subsequently, the modified command components J′x=U′ cos φ and J′y=U′ sin φ are obtained, which method ensures simultaneity between the two components J′x and J′y. Selectable damping routines to the input commands are applied to the values J′x=U′ cos φ and J′y=U′ sin φ together with the rotation command ω′ at this level. An integrator stores the output value Wyi, which is the instantaneous command value for the athwart distance Wyo of each drive wheel from the centre line.

During start up of the system this integrator is initialised with Wyo=Wyi in order to ensure bump free start up of the system. During operation the integrator accepts input commands from the two push buttons SHIFT-WIDE and SHIFT-NARROW in FIG. 16 to increase or decrease the value of Wyi. The value Wyo represents the distance of each drive wheel from the centre line of the drive chassis and is to be taken as positive for the right hand drive wheel and negative for the left hand wheel.

The difference between the two is used to generate the correction s′y=K1(Wyi−Wyo), which is added to the commands from the joystick in the athwart direction to the wheel control. This causes the wheels to approach the required distance between them in an exponential manner with a time constant equal to K1 if the bandwidth of the subsequent control system is sufficiently larger than 1/K1.

The remaining motion commands originate directly from Joystick manipulations generating the two vector components J′x and J′y as well as ω′, which combine with the shift command in accordance with the above formulae to generate the two wheel command vectors: VWx=J′x−ω′Wy (longitudinal direction) and: VWy=J′y+ω′Wx+s′y (athwart direction). This set of wheel commands is generated separately for each bogle, and differs for each bogie in relation to the different wheel co-ordinates in the overall chassis co-ordinate system. From the root of the sum of squares of these two command vectors is derived the drive wheel command speed VWi (always a positive number).

Each of these vectors divided by VWi subject to VWi>0, generate sin ψi and cos ψi where ψi is the input command angle for the wheel drive direction in the overall chassis co-ordinate system. The values VWi subject to VWi>0, sin ψi and cos ψi are generated by the central control unit with reference to the overall chassis co-ordinate system for each of the active bogies and transmitted on digital form to each bogie together with the normalized chassis rotation command ω′.

These signals are preferably transmitted from the central control unit CCU to each of the bogle control devices 3 via an optocoupler transfer 24 for galvanic separation of the central control unit CCU and the bogle control devices 3, respectively. Likewise, monitoring information may be re-transmitted from each of the bogie control devices 3 back to the central control unit via similar optocouplers (not shown).

### Bogie Control Device

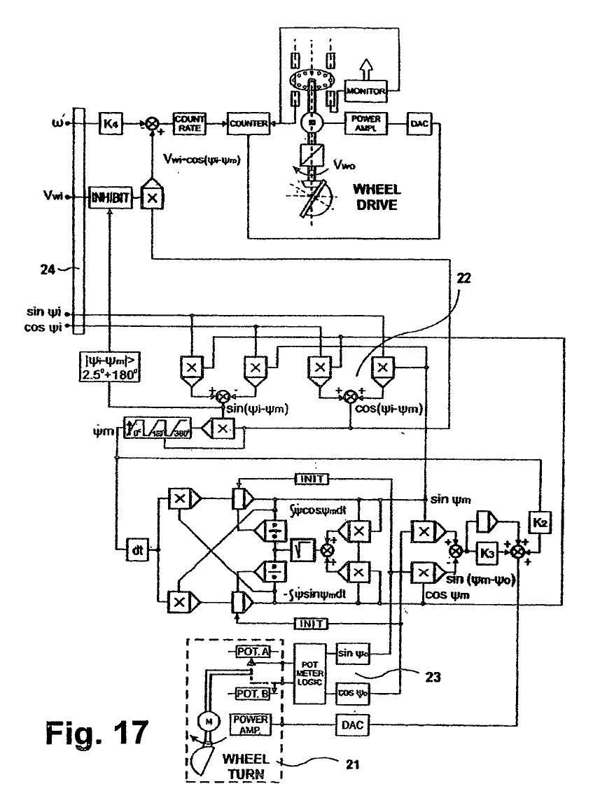

The mathematical model of Wheel Turn will now be described with reference to FIG. 17, which is a diagrammatic Illustration or a block diagram of the electronic bogie control device 3 arranged at each bogie unit 2. The wheel turn part of FIG. 17 defined by a dotted line frame is indicated by 21 and comprises mainly of two integrators executing the following two relations:

sin ψₘ=∫\dot{ψ}ₘ cos ψₘdt

cos ψₘ=∫\dot{ψ}ₘ sin ψₘdt

subject to radius normalization.

The input command to this model is the value \dot{ψ}ₘ (required model rate of turn) generated in the Angular Difference Group 22. The terms to be integrated are generated by the input rate of turn and the output values of the model, cos ψm and sin ψm, respectively. The root of the sum of the squared output values is used to maintain the integrator outputs on a unity radius value. Thus, the whole block thus constitutes an unlimited circular integrator of the input value \dot{ψ}ₘ. The two integrators can, when required and particularly at power-up, be initialised with the values cos ψo and sin ψo, representing the actual angular position of the physical drive wheel housing. The purpose of this mathematical model is to obtain a controlled rotation of the physical drive wheel housing, with a known and noise-free value of \dot{ψ} irrespective of any external disturbances of the physical drive wheel housing.

The physical drive wheel housing is subsequently locked on to the mathematical model through a servo control loop 23, the details of which are shown in FIG. 17. The input command value to this servo is the sine of the angular difference between the physical drive wheel housing and the mathematical model given by sin(ψm−ψo)=sin ψm cos ψo−cos ψm sin ψo. The gain coefficient K3 controls the bandwidth of this loop, which must be significantly larger than what results from the maximum rate of turn permitted into the mathematical model of wheel direction.

The feed-forward of \dot{ψ}ₘ through the coefficient K2 ensures, that the dynamic value of sin(ψm−ψo) is always small, K2 having a value matching the required servo input for the rate of turn in question. Thus, the correspondence between the physical drive wheel housing and the mathematical model is always very good up to the torque limit of the wheel turn servo motor.

### The Angular Difference Group

This group consists mainly of the four multipliers evaluating the terms:

sin(ψi−ψm)=sin ψl cos ψm−cos ψi sin ψm

cos(ψi−ψm)=cos ψi cos ψm+sin ψi sin ψm

which identify the angular difference (ψi−ψm) between the wheel turn model direction ψm and the required direction ψi of the physical wheel housing. By one further multiplication the following term is obtained:

½ sin²(ψi−ψm)=sin(ψl−ψm)cos(ψi−ψm),

which identifies the double angular difference. Using this value as a command input to the wheel turn model, two stable and two unstable balance conditions are obtained:

The two stable ones are (ψi−ψm)=0 and (ψi−ψm)=π, and

the two unstable ones are (ψi−ψm)=π/2 and (ψi−ψm)=3π/2.

This means, that the mathematical model and, consequently, also the physical wheel housing will line up either parallel to, or anti-parallel to the required direction ψi, whichever is the nearer.

This saves time and energy in the wheel turn motion, because the wheel turn housing will never need to turn more than an angle π/2 to attain any new required direction. By subsequently multiplying the required wheel drive speed VWi, which is always a positive value, with the term cos(ψi−ψm) and use cos(ψi−ψm)VWI as the command value for wheel drive speed, it is ensured, that motion is always obtained in the correct direction irrespective of the choice between the two alignment possibilities.

Instead of directly using the term sin 2(ψi−ψm) as the command input to the wheel turn model, a modified version, which generates a linear variation around the two stable balance conditions up to a well-defined maximum value and suppresses actual zeroes at the unstable conditions.

### Wheel Drive Command

As already mentioned, the term cos(ψi−ψm)VWi is applied as the input command. However, because the wheel tread is not moving along a trajectory traced out by centre axis of the wheel with its given co-ordinates, but at a trajectory offset from this by the amount of the wheel offset, another term ω′K4, where K4 is the wheel offset in meters, is subtracted from the wheel speed command. This compensates for the wheel tracing out a curve of a slightly modified radius in a turning condition. Further the command is subject to some inhibit and acceleration constraints as a tool to ensure smooth operation during varying operational conditions. The actual wheel drive servo is a digital/analogue system referring to up/down counts generated from a counter wheel directly on the motor shaft. The accumulated output counts are subtracted from similarly accumulated command counts, the resulting difference (positive or negative) converted into analogue form and given as the input to the power amplifier for the wheel drive motor M2.

The accumulated input counts result from a pulse rate generated in direct proportion to the finished wheel speed command cos(ψi−ψm)VWi−ω′K4 and subject to various inhibit conditions. The output counts from the counter wheel are duplicated into a monitor function, such that if the permissible mutual status of the photo read outs should be violated, a STOP condition is issued throughout the entire system and prevents any further driving.

### Limiting Considerations

Apart from the obvious limitations on speed, force and torque set by the control servos involved, a drive system of this nature requires some further considerations.

As a result of combined drive and turn movements of the total system, either wheel may get into the situation of receiving a drive command which reduces in magnitude towards zero, passes through or very near to zero and again increases in the opposite direction. If this takes place exactly through zero, this particular configuration is able to cope, as the drive command just goes through zero and then comes up again opposite without changing the orientation of the wheel housing. However, in most cases the command will just miss the exact zero point by a small amount, in which case the wheel housing, because of the polar co-ordinate nature of the wheel system, will be called upon to turn very fast in order to follow the actual command around.

If the limits of this capability are exceeded, jerks will be experienced in the drive motion of the total system. For this reason it is advantageous to set up restrictions of the fundamental command group (J′x, J′y, ω′, s′y), such that VWI cannot get below a certain value if U′>VWi. Such conditions can be set up in various ways, the details of which will be related to the actual application of the drive system.

The following could be chosen as an example:

If (VWi<VWi,min) [symbol] (U′>2VWi,min); then [J′x+2VWi,min cos ψi, J′y+2VWi,min sin ψi]; else [J′x, J′y];

where VWi,min is a minimum value of VWi below which uncertainties in the orientation determination of the wheel housing may become unacceptable.

It should be understood that various modifications and amendments of the actuating device and the wheel drive system described above and shown in the drawings could be made without departing from the scope of the following claims. As an example, the omni drive wheels used could be of any known type other than that described, and the central control unit as well as the electronic bogie control devices 3 could be modified as long as a similar function is performed.

1. An actuating device configured to manually actuate a driving and steering mechanism for a wheeled, power driven object or vehicle, said actuating device comprising:
a base member;
an actuating member having gripping means and being supported by the base member so as to be displaceable relative to the base member in at least one plane;
at least first and second force transducers, the first transducer being arranged to receive a force component manually applied to the actuating member in a first direction within said plane, and the second force transducer being arranged to receive a force component manually applied to the actuating member in a second direction, the second direction being transverse to the first direction and within said plane, wherein
each of said at least first and second force transducers are adapted to generate an output signal for the driving and steering mechanism responsive to the strength of the force component received.

2. An actuating device according to claim 1, wherein said first and second directions extend at mutual right angles.

3. An actuating device according to claim 1, wherein said first direction extends in the normal direction of travel of the vehicle.

4. An actuating device according to claim 1, wherein said gripping means comprises a pair of gripping handles, the gripping handles being mounted on the actuating member and symmetrically arranged about a line along the first direction midway between the gripping handles, said first force transducer and a similar third force transducer being arranged symmetrically about a line along the first direction midway between the first and third force transducer, said third force transducer and said first force transducer being arranged to receive a force component manually applied to the actuating member in said first direction.

5. An actuating device according to claim 1, wherein each force transducer is mounted to the base member, each force transducer having a force transmitting member extending into and engaging with the walls of an associated recess in the actuating member, said recess being shaped such that substantially only a force component in the direction associated with the transducer may be transmitted from the actuating member to the force transducer via said transmitting member.

6. An actuating device according to claim 1, wherein the force transducers each comprise a strain gauge.

7. An actuating device according to claim 6, wherein each force transducer comprises a cantilever beam having one or more strain gauges mounted thereon, the actuating member being configured to apply a force to the free end of the beam so as to generate bending stresses in the beam.

8. An actuating device according to claim 1, wherein the actuating member is configured to floating on a liquid film or layer.

9. An actuating device according to claim 8, wherein said liquid film or layer comprises viscous oil or grease.

10. An actuating device according to claim 9, wherein the liquid film or layer comprises damping grease.

11. An actuating device according to claim 1, further comprising an electronic circuit configured to receive the output signals from the force transducers and to process the output signals prior to transmitting them to the driving and steering system of the vehicle so as to obtain vehicle movement of greater magnitude than if the vehicle had been manually driven by the forces applied to the gripping means.

12. A method of manually actuating a driving and steering mechanism for a wheeled, power driven object or vehicle, said method comprising:
applying a manual force to an actuating member;
decomposing the manual force into at least two components extending in mutually intersecting, directions;
applying each of said force components to a respective transducer; and
transmitting from each of said transducers to the steering mechanism an output signal, responsive to the strength of the force component received by the transducer relating to the respective direction.

13. A method according to claim 12, wherein the manual force is applied to gripping means provided on the actuating member, the actuating member being supported by a base member so as to be displaceable thereon in said directions within a plane.

14. A method according to claim 12, wherein said directions extend at right angles.

15. A method according to claim 12, wherein one of said directions extends in the normal direction of travel of the vehicle.

16. A method according to claim 13, wherein the actuating member is configured to float on a liquid film or layer.

17. A method according to claim 16, wherein said liquid film or layer comprises viscous oil or grease.

18. A method according to claim 17, wherein the liquid film or layer comprises damping grease.

19. A method according to claim 12, wherein the transducer stiffness and the mass of the control plate define a natural frequency of resonance of the movable parts of the actuator device substantially exceeding frequencies of environmental vibrations.

20. A method according to claim 18, wherein the liquid layer is arranged so as to provide one of about critical and about just overcritical damping of the natural free resonance vibrations.

21. A method according to claim 12, wherein the output signals from the transducers are configured to be transmitted to an electronic circuit, in which the output signals are processed prior to further transmitting them to a driving and steering system of a wheeled vehicle so as to obtain vehicle movement of greater magnitude than if the vehicle had been manually driven by the force applied to the actuating member.

22. A drive wheel system configured to drive an object, said wheel system comprising:
at least two separate wheeled units or bogies mounted at selected locations on the object to support the object, each wheeled unit or bogie comprising:
a frame, wherein at least one wheel member is rotatably mounted to the frame;
a driving mechanism configured to rotate the wheel member relative to the frame; and
a steering mechanism configured to move the wheel member relative to the frame;
an electronic control unit configured to control the driving mechanism and the steering mechanism of each of said wheeled units or bogies, the electronic control unit comprising:
a pre-programmed control device at each of said wheeled units or bogies;
a signal transmitter; and
a pre-programmed central control unit configured to output command signals to each of the pre-programmed control devices via the signal transmitter in response to input command signals; and
an actuating device according to claim 1, the output signals generated by the transducers being configured to be transmitted to the electronic control unit.

23. A system according to claim 22, wherein the central control unit comprises a first programming device configured to receive information about the mutual positions of the wheeled units or bogies on said object.

24. A system according to claim 22, wherein each bogie control device comprises a second programming device configured to receive information about the orientation of the associated wheeled unit about a selected common axis.

25. A system according to claim 22, wherein the signal transmitter comprises a galvanic isolating device.

26. A system according to claim 25, wherein the galvanic isolating device comprises an optocoupler.

27. A system according to claim 22, wherein the central control unit comprises data converter configured to convert output command signals to be transmitted to the bogie control devices at the wheeled units or bogies into serial digital signals.

28. A system according to claim 22, wherein the central control unit and each of the bogie control devices each comprise a portion of the electronic control unit.

29. A system according to claim 22, wherein the driving mechanism and the steering mechanism of the wheeled units or bogies each comprise a motors selected from the group consisting of electric motors, hydraulic motors, pneumatic motors, steam engines, thermodynamic engines, and internal combustion engines.

30. A system according to claim 22, wherein the wheeled units or bogies of the system are substantially identical.

31. A system according claim 22, wherein each wheel member comprises a support member, a wheel element, and a drive shaft, the drive shaft engaging a drive surface on the wheel element and is configured to rotatably drive the wheel element relative to the support member, the drive shaft comprising a longitudinal axis, wherein the engagement of the drive shaft and the drive surface defines in vertical cross-section a line of engagement that is at an acute angle with respect to the longitudinal axis, the wheel element comprising a surface contacting portion extending about its periphery and being positioned such that the wheel element is intersected by the line of engagement substantially at where the wheel element contacts a supporting surface.

32. A system according to claim 31, wherein the drive shaft is substantially normal to the supporting surface.

33. A system according to claim 31, wherein the angle is between about 10° and about 25°.

34. A system according to claim 31, wherein the support member comprises a substantially hemispherical member and the wheel element is rotatable about an axle extending normal to an inner surface of the hemispherical member.

35. A method of rendering an object self-propelling with a drive wheel system according to claim 24, said method comprising:
mounting at least two of said wheeled units or bogies on the object at selected locations thereof and with selected orientations relative to a certain directions;
programming said first programming device by inputting information about the positions of the wheeled units or bogies on said object;
programming said second programming device by inputting information about the orientation of the associated wheeled unit relative to a selected direction, and
inputting command signals to the central control unit from the actuating device so as to move the vehicle along a desired path.

36. A method according to claim 35, comprising relating the information about the positions of the wheeled units or bogies to an actual or imaginary co-ordinate system on said object.

37. A method according to claim 36, wherein said selected direction is parallel to one of the axes of the co-ordinate system.

38. A method according to claim 34, wherein the electronic control unit is pre-programmed to ensure that the steering mechanism moves all wheel members of the wheeled units or bogies mounted on the object such that any time during driving all wheel members are either moving along substantially parallel lines or substantially concentric arcs of circles.

39. A method according to claim 35, wherein the command signals are transmitted from the central control unit to the control devices at the wheeled units or bogies as serial digital signals.

40. A method according to claim 35, wherein the object to be rendered self-propelled is a manually driven vehicle having a plurality of supporting wheels, wherein at least two supporting wheels are replaced such that the vehicle is supported by at least two of said wheeled units or bogies and freely swiveling wheels or casters only.

41. A method according to claim 35, wherein the electronic control unit is mounted on the object.
